(19) United States
(12) Patent Application Publication
(10) Pub. No.: US 2019/0007740 A1
(43) Pub. Date: Jan. 3, 2019

(54) CONTENT RECOMMENDATIONS ASSOCIATED WITH CONTEXT PROVIDED BY A VIEWER

(71) Applicant: THOMSON LICENSING, Issy les Moulineaux (FR)

(72) Inventors: Branislav KVETON, San Jose, CA (US); Subrahmanya Sandilya BHAMIDIPATI, Palo Alto, CA (US)

(73) Assignee: THOMSON LICENSING, Issy les Moulineaux (FR)

(21) Appl. No.: 15/510,692

(22) PCT Filed: Sep. 14, 2015
(86) PCT No.: PCT/US2015/049906

§ 371 Date: Mar. 12, 2017

Related U.S. Application Data
(60) Provisional application No. 62/049,874, filed on Sep. 12, 2014.

(51) Int. Cl. H04N 21/466; H04N 21/458; H04N 21/45; H04N 21/472

(52) U.S. Cl. CPC H04N 21/4668; H04N 21/47202; H04N 21/4524; H04N 21/458

(57) ABSTRACT

Various features described herein may be embodied in various apparatuses. An apparatus may recommend content to a viewer. The apparatus may receive a selection from the viewer of a condition to associate with the content. The condition may be included in a list of conditions displayed for the viewer. The condition may be a period of time selected by the viewer. The condition may be a weather condition selected by the viewer. The context condition may a location selected by the viewer. When the condition does not exist, the apparatus may refrain from providing the content as a recommendation for the viewer. Afterwards, the apparatus may add the content to a queue associated with the content. When the condition does exist, the apparatus may provide the content as a recommendation for the viewer. Various methods and computer-readable medium may also provide various embodiments of such features.

### CROSS REFERENCE

This application claims priority to a U.S. Provisional Application Ser. No. 62/049,874, filed on Sep. 12, 2014, which is herein incorporated by reference in its entirety.

### TECHNICAL FIELD

The present disclosure generally relates to content recommendations and, more particularly, to content recommendations associated with a context provided by a viewer.

### BACKGROUND

Existing systems may recommend content (e.g., a movie) for watching by a viewer based on other content (e.g., other movies) watched by that viewer. Such systems may be helpful in recommending content that the viewer will likely enjoy. However, the viewer may not wish to watch the recommended content at the time that the content is recommended. In some instances, the particular circumstances of the viewer may prohibit the viewer from watching the recommended content. For example, the viewer may not have enough time to watch the recommended content at the time that content is recommended. Nevertheless, the viewer may still wish to watch the recommended content at some time in the future. The future circumstances of the viewer may allow the viewer to watch the recommended content. However, existing systems do not provide the viewer with an opportunity to inform the system about the circumstances under which the viewer prefers to watch the recommended content. Existing systems may benefit from enhancements that improve upon such limitations.

### SUMMARY

Various features described herein may be embodied in various apparatuses. An apparatus may recommend content to a viewer. The apparatus may receive a selection from the viewer of a context to associate with the content. The context may be included in a list of contexts displayed for the viewer. The context may be a period of time selected by the viewer. The context may be a weather condition selected by the viewer. The context may be a location selected by the viewer. When the context does not exist, the apparatus may refrain from providing the content as a recommendation for the viewer. Afterwards, the apparatus may add the content to a queue associated with the context. When the context does exist, the apparatus may provide the content as a recommendation for the viewer. Various methods and computer-readable medium may also provide various embodiments of such features. The foregoing is merely a summary of various features described in greater detail herein. Additional features are also described herein. The embodiments described herein may be implemented in any combination or sub-combination, even if not explicitly described herein.

### BRIEF DESCRIPTION OF DRAWINGS

FIGS. 1A-1B are block diagrams illustrating examples of user systems according to various embodiments.

FIG. 2 is a block diagram illustrating an example of components of a user system according to various embodiments.

FIGS. 3A-3C are diagrams illustrating examples of devices that include the components according to various embodiments.

FIGS. 4A-4E are diagrams illustrating an example of a sequence of items displayed to the viewer according to various embodiments.

FIG. 5 is a flow diagram illustrating an example of methods/processes/functions/steps according to various embodiments.

### DESCRIPTION OF EMBODIMENTS

Provided herein is a description of various embodiments of various features. However, the description provided herein is not intended to limit the scope of the present disclosure. One of ordinary skill in the art will appreciate that the features described herein may be embodied in additional and/or alternative embodiments without deviating from the scope of the present disclosure.

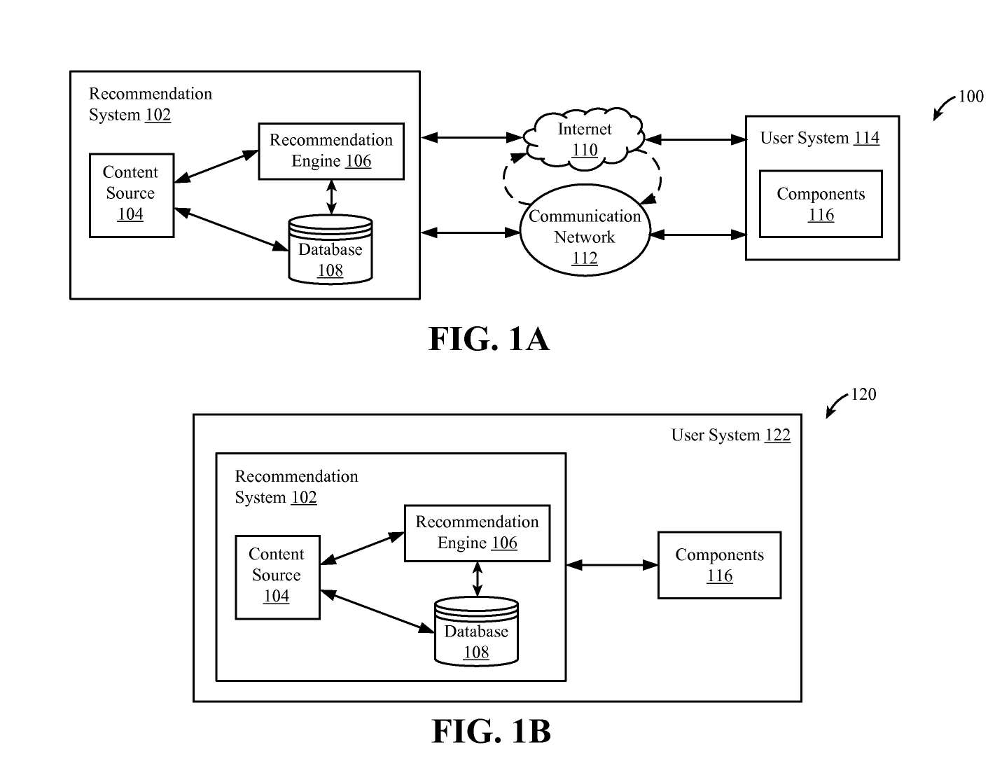

FIG. 1A is a block diagram 100 illustrating an example of a user system 114 for providing content to a viewer. The content may originate from a content source 104 of a recommendation system 102. The content may include various forms of media, such as any movie, image, pay-per-view content, webpage, audio, video, icon, video game, software, and/or other type of suitable media. The content may also include broadcast content, including content from a national broadcast service, such as the American Broadcasting Company (ABC), National Broadcasting Company (NBC), and Columbia Broadcasting System (CBS). The content may also include various types of over-the-air broadcast content, satellite broadcast content, and/or cable broadcast content. The content may also include various media originating from or hosted by Internet-based entities, such as YouTube™, Netflix™, and/or Hulu™. The content may also include other examples of media without deviating from the scope of the present disclosure.

The database 108 of the recommendation system 102 may store data pertaining to the content viewing preferences of one or more viewers. The database 108 may collect and store such content viewing preferences based on previous content selections by the one or more viewers. Examples of such data may include the genre, the duration, the title, the date, the description, and/or the keywords associated with previous content selections by the one or more viewers. The recommendation engine 106 may use the data stored in the database 108 to make selections of recommend content for the one or more viewers. For instance, the recommendation engine 106 may use the genre, the duration, the title, the date, the description, and/or the keywords associated with previous content selections to recommend similar content for the one or more viewers.

The recommendation system 102 may provide content to the user system 114 for viewing by the viewer. The recommendation system 102 and the user system 114 may communicate with each other via the Internet 110 and/or the communication network 112. The user system 114 may be connected to the Internet 110 via a wired and/or wireless high-speed broadband connection, and/or any other suitable form of connection to the Internet. The communication network 112 may include cable networks, satellite networks, regional networks, local networks, and/or any other suitable communication network.

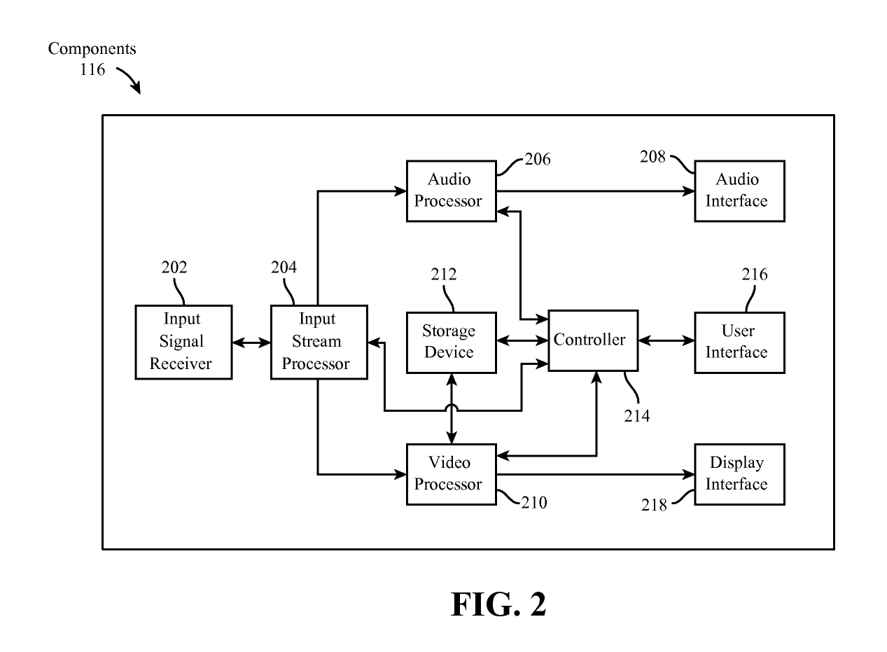

A user (e.g., a viewer) may use the user system 114 to view the recommended content. The user system 114 may include various components 116. The components 116 of the user system 114 may include various hardware components and/or software components. A detailed description of the components 116 is provided below with reference to FIG. 2 and, therefore, will not be repeated here.

In FIG. 1A, the content is stored remotely (e.g., the content source 104 is not part of the user system 114). Accordingly, content from the content source 104 is transmitted via the Internet 110 and/or the communication network 112 to the user system 114 for viewing by the viewer. However, the diagram 100 illustrated in FIG. 1A is a non-limiting example. Alternative embodiments exist and are within the scope of the present disclosure. FIG. 1B is a block diagram 120 illustrating another example of a user system 122 for providing content to a viewer. In FIG. 1B, the content is stored locally (e.g., the content source 104 is part of the user system 122). For example, in various embodiments, the recommendation system 102 is included as a part of the user system 122. Various features illustrated in FIG. 1B are similar to features illustrated and described with reference to FIG. 1A. Accordingly, a description of such similar features will not be repeated here. FIGS. 1A-1B are non-limiting examples of various embodiments of a user system, and alternative embodiments of a user system exist and are within the scope of the present disclosure.

FIG. 2 is a block diagram illustrating an example of the components 116 of a user system, such as the user system 114, 122. The components 116 may include an input signal receiver 202 that may receive and process content. The input signal receiver 202 may receive different types of content from various sources (e.g., the Internet 110 and/or the communication network 112). The input signal receiver 202 may process content and separate the content based on various parameters. The input signal receiver 202 may function as an entry point, or gateway, for a home network system that includes additional devices configured as client or peer devices in a home network. The input signal receiver 202 may include, for example, receiver circuits used for receiving, demodulation, and/or decoding signals provided over one of the several possible networks. Such networks may include over-the-air networks, cable networks, satellite networks, and/or other networks using Ethernet, fiber optics, and/or phone lines. The input signal receiver 202 may also receive input signals from a remote controller, a keyboard, a mouse, a touch panel, a touch screen, and/or any other suitable input device adapted for user control. Such input signals may be received via a wired connection and/or a wireless connection, such as infra-red (IR), radio frequency (RF) communications, Bluetooth™, wireless fidelity (Wi-Fi), and/or any other suitable wireless technology. The components 116 may also include a display interface 218. In various embodiments, the display interface 218 may be an external display coupled to input signal receiver 202. For example, the display interface 218 may be a television that is connected to a set-top box. In various embodiments, the input signal receiver 202 and the display interface 218 may be parts of a single apparatus. For example, the input signal receiver 202 and the display interface 218 may be parts of a single laptop computer. The display interface 218 may be, for example, a conventional two-dimensional (2-D)-type display, a three-dimensional (3-D)-type display, and/or any other suitable type of display adapted to show content to the viewer.

The components 116 may also include a storage device 212. The storage device 212 may store computer-executable instructions for performing operations according to various embodiments. For example, the computer-executable instructions may be stored in non-transitory computer-readable medium. The computer-executable instructions may be executed by one or more processors. In various embodiments, the one or more processors (e.g., one or more microprocessors) may be included in a controller 214. The storage device 212 may be, for example, a hard disk drive, one or more large capacity integrated electronic memories, such as static RAM (SRAM), dynamic RAM (DRAM), etc., an interchangeable optical disk storage system, such as a compact disk (CD) drive, digital video disk (DVD) drive, etc., and/or any suitable storage medium configured to store data and/or information. In various embodiments, the storage device 212 may also store the content that can be shown to the viewer. The storage device 212 may allow retrieval and playback of the content. Content playback may be performed under the control of the controller 214 and commands, e.g., navigation instructions, such as fast-forward (FF) and/or rewind (RW), from a user interface 216. The user interface 216 may receive and process user inputs, such as keystrokes, button presses, touch inputs, audio input, and/or other suitable forms of input from a user. The user interface 216 may interface with a cellular phone, a tablet, a mouse, a remote controller, and/or any other suitable apparatus that can be operated or controlled by the user.

The components 116 may also include an input stream processor 204. The input stream processor 204 may perform signal selection and processing. In various embodiments, the input stream processor 204 may separate video content from audio content for the content being received by the input signal receiver 202. The audio content may be provided to an audio processor 206 for conversion from the received format, such as a compressed digital signal, to an analog waveform signal. The analog waveform signal may be provided to an audio interface 208. In various embodiments, the audio interface 208 may provide a digital signal to an audio output device or display device using a High-Definition Multimedia Interface (HDMI) cable, an audio interface, such as via a Sony/Philips Digital Interconnect Format (SPDIF), etc, and/or any other suitable mechanism of providing such signals. The audio interface 208 may also include amplifiers for driving one more sets of speakers. The video output from the input stream processor 204 may be provided to a video processor 210. The video signal may be one of various formats. The video processor 210 may perform any necessary conversion of the video content. The video processor 210 may also perform any necessary compression of the video content for purposes of storage in the storage device 212. The controller 214 may be connected via a bus to various elements of the components 116, including the input stream processor 204, the audio processor 206, the video processor 210, the storage device 212, and/or the user interface 216.

The foregoing provides a description of non-limiting examples of the components 116 of a user system, such as the user system 114, 122, according to various embodiments. However, one of ordinary skill in the art will understand that alternative embodiments of the components 116 exist and are within the scope of the present disclosure. For example, the components 116 may include similar, additional, and/or fewer elements relative to the elements described with reference to FIG. 2 without deviating from the scope of the present disclosure.

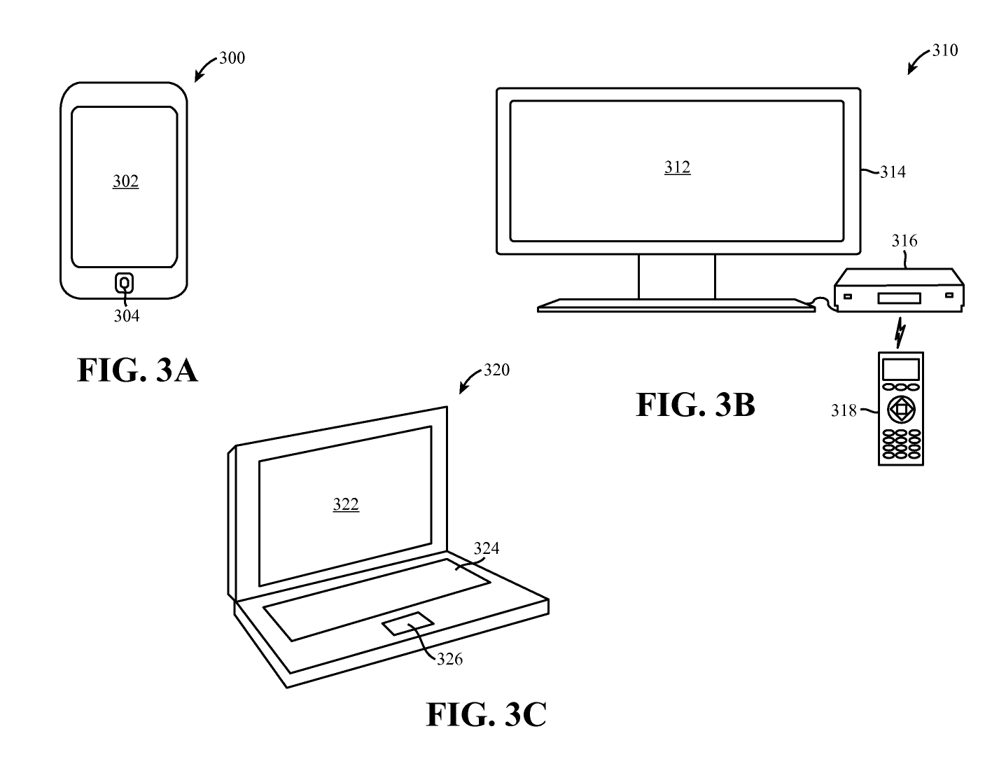

FIG. 3A is a diagram illustrating an example of a mobile device 300 that may include the components 116. Without deviating from the scope of the present disclosure, the mobile device 300 may be a smartphone, a cellular telephone, a tablet computer, and/or any suitable device configured in accordance with the various features described herein. The mobile device 300 may include a display 302 and an input button 304. The display 302 may be configured to display content to a viewer. The display 302 may be a touchscreen configured to receive input signals. The touchscreen may receive inputs via touch from the user. Various technologies may be implemented to detect touch on the touchscreen. The touchscreen may also receive inputs from a stylus. The input button 304 may provide input signals to the mobile device 300. The mobile device 300 may be connected wirelessly to a network of one or more base stations, access points, computers and/or servers. In various embodiments, the content displayed to the viewer may be provided from a remote content source and transmitted to the mobile device 300 via a wireless connection. For example, referring to FIG. 1A, the content may be remotely stored in the content source 104 and communicated to the user system 114 (e.g., the mobile device 300) via the Internet 110 and/or the communication network 112. Such communication may be performed in accordance with various protocols and/or standards (e.g., IEEE 802.11, 4G/LTE, LTE Advanced, 3G, CDMA, etc.). In various embodiments, the content may be stored locally in the mobile device 300. For example, referring to FIG. 1B, the content may be stored locally in the content source 104, which is included in the user system 122 (e.g., the mobile device 300).

FIG. 3B is a diagram illustrating an example of an entertainment system 310 that may include the components 116. The entertainment system 310 may include a television 314, a set-top box 316, and/or a remote control 318. The television 314 includes a display 312. The set-top box 316 may be connected, by a wire or wirelessly, to the television 314. The set-top box 316 may be a cable box, a game console, a modem, a gateway, a media player (e.g., a BlueRay™ player and/or a digital video disc (DVD) player), and/or any other suitable device configured in accordance with the features described herein. The remote control 318 may send and/or receive information to/from the set-top box 316. One of ordinary skill in the art will understand that the entertainment system 310 may exclude certain elements (e.g., the remote control 318) and/or combine multiple elements (e.g., combine the television 314 and the set-top box 316 into a single apparatus) without deviating from the scope of the present disclosure. One of ordinary skill in the art will further understand that the entertainment system 310 may be any suitable apparatus, device, and/or system configured in accordance with the various features described herein. The entertainment system 310 may be connected, by a wire or wirelessly, to a network of one or more access points, computers and/or servers. In various embodiments, the content displayed to the viewer may be provided from a remote content source and transmitted to the entertainment system 310. For example, referring to FIG. 1A, the content may be remotely stored in the content source 104 and communicated to the user system 114 (e.g., the entertainment system 310) via the Internet 110 and/or the communication network 112. Such communication may be performed in accordance with various protocols and/or standards (e.g., IEEE 802.11, etc.). In various embodiments, the content may be stored locally in the entertainment system 310. For example, referring to FIG. 1B, the content may be stored locally in the content source 104, which is included in the user system 122 (e.g., the entertainment system 310).

FIG. 3C is a diagram illustrating an example of a computer 320 that may include the components 116. The computer 320 may include a screen 322, a touchpad 326, and/or a keyboard 324. The display 322 may be configured to display content to a viewer. The display 322 may also be a touchscreen configured to receive input signals. The touchscreen may be configured to receive inputs via touch from the user. Various technologies may be used to detect touch on the touchscreen. The touchscreen may also be configured to receive inputs from a stylus. The touchpad 326 and/or keyboard 324 may also provide input signals to the computer 320. FIG. 3C illustrates a non-limiting example of the computer 320 as a laptop computer. However, one of ordinary skill will understand that the computer 320 may also be a desktop computer, a wall-mounted touchscreen computer, a tablet computer with a mountable keyboard (e.g., a Microsoft™ Surface tablet), a ultrabook computer, a notebook computer, and/or any other suitable apparatus without deviating from the scope of the present disclosure. The computer 320 may be connected, by a wire or wirelessly, to a network of one or more base stations, access points, computers and/or servers. In various embodiments, the content displayed to the viewer may be provided from a remote content source and transmitted to the computer 320. For example, referring to FIG. 1A, the content may be remotely stored in the content source 104 and communicated to the user system 114 (e.g., the computer 320) via the Internet 110 and/or the communication network 112. Such communication may be performed in accordance with various protocols and/or standards (e.g., IEEE 802.11, 4G/LTE, LTE Advanced, 3G, CDMA, etc.). In various embodiments, the content may be stored locally in the computer 320. For example, referring to FIG. 1B, the content may be stored locally in the content source 104, which is included in the user system 122 (e.g., the computer 320). One of ordinary skill in the art will appreciate that FIGS. 3A-3C illustrate non-limiting examples of various devices, systems, and/or apparatuses that may include the components 116 according to various embodiments. Alternative embodiments exist and are within the scope of the present disclosure.

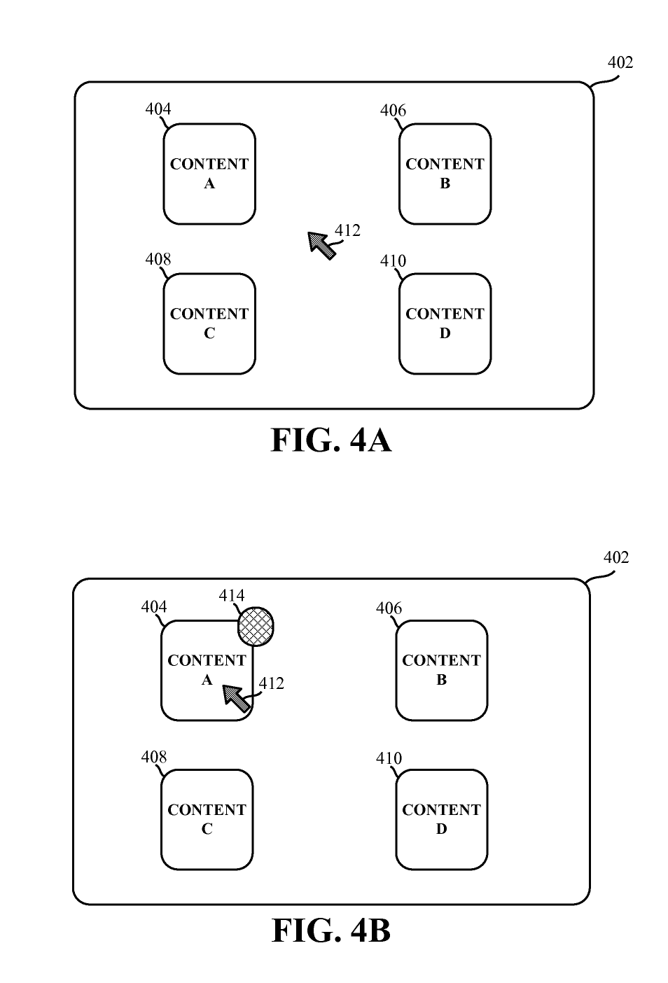

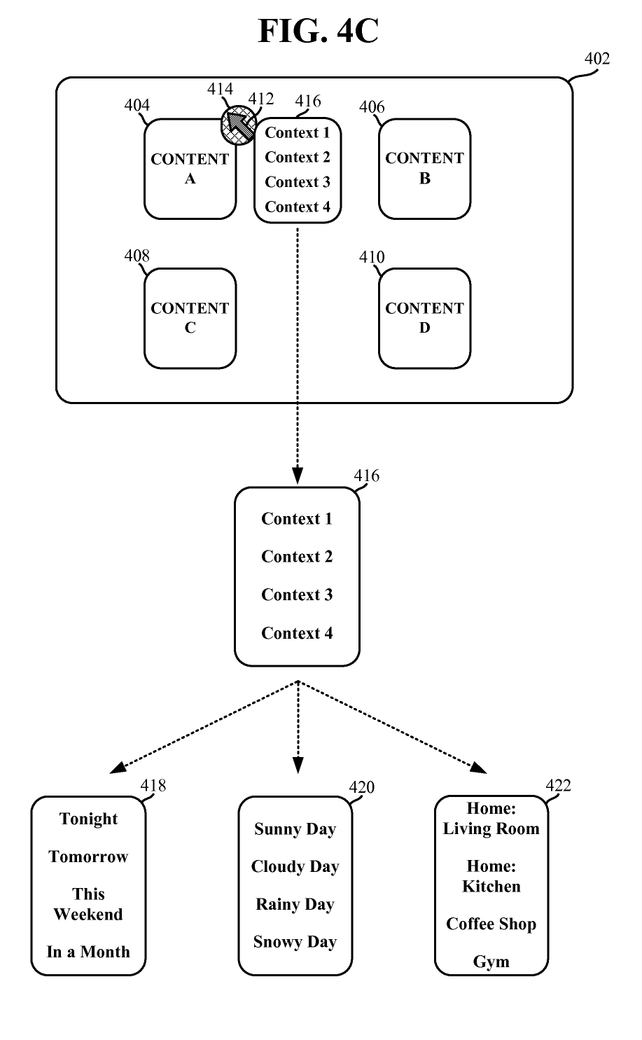

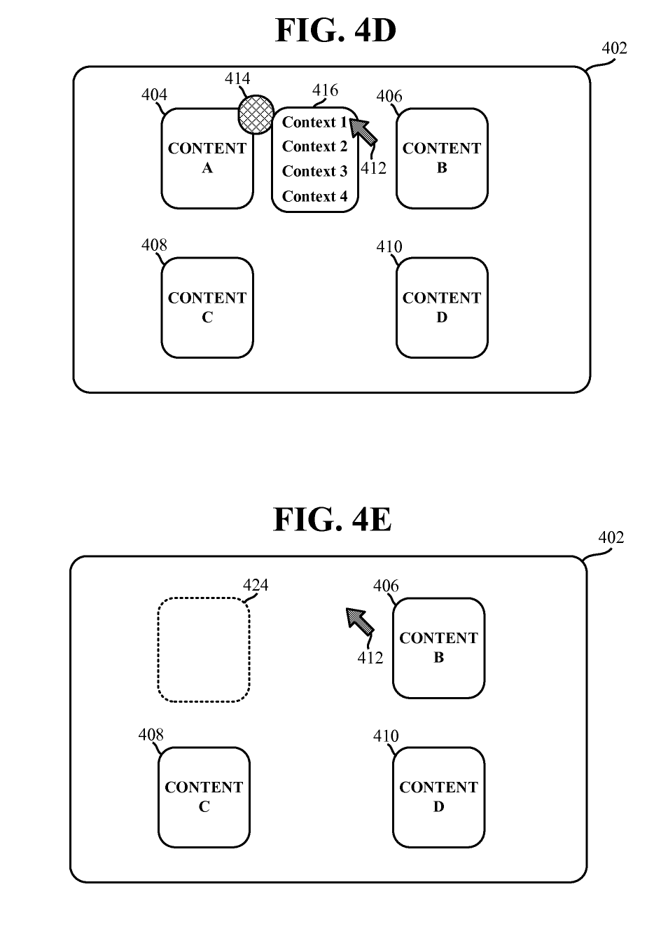

FIGS. 4A-4E are diagrams illustrating an example of a sequence of items displayed to the viewer according to various embodiments. FIGS. 4A-4E respectively illustrate a first, a second, a third, a fourth, and a fifth set of items shown to the viewer of the display 402. In FIGS. 4A-4E, the display 402 may be the same as one or more of the displays 302, 312, 322 respectively illustrated in FIGS. 3A-3C. FIG. 4A illustrates the first set of items shown to the viewer of the display 402. The display 402 may show content, such as Content A 404, Content B 406, Content C 408, and Content D 410. A non-limiting description of the various embodiments of what may constitute ‘content’ is provided above with reference to FIG. 1A and, therefore, will not be repeated here. The content (e.g., Content A 404, Content B 406, Content C 408, and/or Content D 410) may be content recommended by the recommendation system 102 (see FIGS. 1A-1B). Although FIG. 4A illustrates four items of content (e.g., Content A 404, Content B 406, Content C 408, and Content D 410), one of ordinary skill in the art will appreciate that a fewer number and/or a greater number of items of content may be shown to the viewer of the display 402 without deviating from the scope of the present disclosure.

In various embodiments, a pointer 412 may also be shown to the viewer of the display 402. The pointer 412 may be controlled by the viewer to make various selections. For example, the pointer 412 may be a mouse icon and/or any other suitable indicator that can be controlled by the viewer. The pointer 412 may be controlled by the viewer using various input devices. For example, referring to FIG. 3A, control may be provided by user touch to the touchscreen of the mobile device 300. As another example, referring to FIG. 3B, control may be provided by the remote control 318, which may communicate with the set-top box 316 of the entertainment system 310. As yet another example, control may be provided by the touchpad 326 and/or the keyboard 324 of the computer 320. One of ordinary skill in the art will understand that additional and/or alternative methods and mechanisms may be implemented for controlling the pointer 412 without deviating from the scope of the present disclosure. One of ordinary skill in the art will also understand that, in various embodiments, the pointer 412 may not be necessary. For example, the viewer may make selections of items on the display 402 using other methods and mechanisms that do not require the pointer 412 to be shown on the display 402.

Initially, as illustrated in FIG. 4A, the pointer 412 may be positioned in an area of the display 402 that is not overlapping with an area where content (e.g., Content A 404, Content B 406, Content C 408, and/or Content D 410) is displayed. As a non-limiting example, Content A 404, Content B 406, Content C 408, and Content D 410 may be icons corresponding to movies. For example, Content A 404 may be an icon corresponding to the Lord of the Rings™ film series. Subsequently, as illustrated in FIG. 4B, the pointer 412 may be moved to an area of the display 402 that is overlapping with an area where such content is displayed. For example, the pointer 412 may be moved to an area that overlaps with Content A 404. When the pointer 412 is moved to an area of the display 402 that is overlapping with an area where such content (e.g., Content A 404) is displayed, a marker 414 may be shown to the viewer of the display 402. In various embodiments, the viewer may need to also select (e.g., “click”) the content (e.g., Content A 404) in order for the marker 414 to be shown to the viewer of the display 402. In various other embodiments, such a selection (e.g., “clicking”) is not necessary. The marker 414 may be an icon, button, and/or any other suitable media. In various embodiments, the marker 414 may be called a “snooze-it” icon. In various embodiments, the marker 414 is shown in an area of the display 402 that is adjacent to and/or overlapping with the content (e.g., Content A 404). For example, referring to FIG. 4B, the marker 414 appears at the upper-right corner of Content A. However, one of ordinary skill in the art will understand that the marker 414 may be shown in any area of the display 402 without deviating from the scope of the present disclosure.

Afterwards, as illustrated in FIG. 4C, the pointer 412 may be moved to an area of the display 402 that is overlapping with an area where the marker 414 is displayed. When the pointer 412 is moved to an area of the display 402 that is overlapping with an area where marker 414 is displayed, a list of contexts 416 may be shown to the viewer of the display 402. In various embodiments, the viewer may need to also select (e.g., “click”) the marker 414 in order for the list of contexts 416 to be shown to the viewer of the display 402. In various other embodiments, such a selection (e.g., “clicking”) is not necessary. The list of contexts 416 may be an icon, button, and/or any other suitable media. In various embodiments, the list of contexts 416 may be shown in an area of the display 402 that is adjacent to and/or overlapping with the marker 414. For example, referring to FIG. 4C, the list of contexts 416 appears near the lower-right-side of the marker 414. However, one of ordinary skill in the art will understand that the list of contexts 416 may be shown in any area of the display 402 without deviating from the scope of the present disclosure.

The list of contexts 416 includes one or more contexts. For example, referring to FIG. 4C, the list of contexts 416 includes Context 1, Context 2, Context 3, and Context 4. Although four contexts are illustrated in the non-limiting example shown in FIG. 4C, one of ordinary skill in the art will understand that a fewer number and/or a greater number of contexts may be included in the list of contexts 416 without deviating from the scope of the present disclosure. Generally, a context refers to a circumstance that can be experienced by the viewer. For example, the context may refer to a period of time. As another example, the context may refer to a weather condition. As yet another example, the context may refer to the location of the viewer. One of ordinary skill in the art will understand that the context may include other circumstances experienced by the viewer without deviating from the scope of the present disclosure.

As described in greater detail above, the content (e.g., Content A 404, Content B 406, Content C 408, and Content D 410) may be recommendations provided by the recommendation system 102 (see FIGS. 1A-1B). Such recommendations may be based on various variables (e.g., specific viewer preferences, past viewing selections by that viewer, etc.). However, the recommended content may not always match the context(s) (e.g., circumstance(s)) of the viewer (at the time that the recommendation is made by the recommendation system 102). For example, as described above, the recommendation system 102 may have recommended the Lord of the Rings™ film series. However, at the time that the recommendation is made by the recommendation system 102, the viewer may not have enough time to watch a movie having a long duration (such as the long duration of the Lord of the Rings™ film series). Nevertheless, the viewer may wish to watch such recommended content at a later time (e.g., when the viewer's circumstances allow for watching such content). For example, referring to the time-related list of contexts 418, the viewer may select to watch such content “tonight,” “tomorrow,” “this weekend,” or “in a month.” Accordingly, the viewer may provide a selection of a context (e.g., “tonight,” “tomorrow,” “this weekend,” or “in a month”) to associate with the content (e.g., the Lord of the Rings™ film series). For purposes of this example, we can assume that the viewer selects the context of “this weekend.” Accordingly, during the weekdays, the content will not be shown on the display 402 (because the context of “this weekend” does not exist). The content (e.g., the Lord of the Rings™ film series) may also be added to a queue, such as a queue associated with the context (e.g., a queue of movies for watching “this weekend”). During the weekend, the content will be shown on the display 402 as a recommendation for the viewer (because the context of “this weekend” will exist). The features described herein have many advantages that will be readily apparent to one of ordinary skill in the art. For example, such features allow the viewer to organize content recommendations based on the context of the viewer. As described in greater detail above, the context can be the circumstances experienced by the viewer. If the context (e.g., the circumstances) of the viewer are not suitable for viewing the recommended content, instead of completely disregarding the recommended content, the viewer can add the recommended content to a corresponding queue. At a later time, when the context (e.g., the circumstances) of the viewer match the context associated with the content, the content can be recommended for viewing by the viewer.

Although the example described above pertains to time (e.g., a period time, such as “this weekend”), one of ordinary skill in the art will understand that the context may be any circumstance experienced by the viewer. For instance, the context may be weather-related. Information about current weather conditions may be obtained from a third party (e.g., an Internet website, a weather-broadcasting service, etc.). As illustrated in the weather-related list of contexts 420, the contexts may include: “sunny day,” “cloudy day,” “rainy day,” and “snowy day.” For the sake of illustration, the recommended content may be the movie Sleepless in Seattle™. The viewer may wish to watch such content during a rainy day (e.g., the viewer associates Sleepless in Seattle™ as a ‘rainy day-type of movie’). At the time that the recommendation is made by the recommendation system 102 (see FIGS. 1A-B), the weather may be sunny. However, the viewer may wish to watch such content at a later time (e.g., when the weather is rainy). Accordingly, the viewer may select a corresponding context (e.g., “rainy day”) to associate with the content (e.g., Sleepless in Seattle™). Accordingly, during non-rainy days, the content will not be shown on the display 402 (because the context of “rainy day” does not exist). The content (e.g., Sleepless in Seattle™) may also be added to a queue, such as a queue associated with the context (e.g., a queue of movies for watching during a “rainy day”). On a rainy day, the content will be shown on the display 402 as a recommendation for the viewer (because the context of “rainy day” will exist). As mentioned above, one of ordinary skill in the art will understand that the context may be any circumstance experienced by the viewer.

As yet another example, the context may be location-related. Information about current location of the viewer may be obtained from the viewer, a global positioning system (GPS) device, a signal triangulation system, an Internet protocol (IP) address, an access point (AP) (e.g., a router or modem), and/or any other suitable technology for location determination. As illustrated in the location-related list of contexts 422, the contexts may include: “home: living room,” “home: kitchen,” “coffee shop,” and “gym.” For example, the recommended content may be a cooking show called Iron Chef America™. The viewer may wish to watch this show in the kitchen of their home. At the time that the content is recommended by the recommendation system 102 (see FIGS. 1A-1B), the viewer may be located at a coffee shop. However, the viewer may wish to watch such content at a later time (e.g., when the viewer is in the kitchen of their home). Accordingly, the viewer may select a corresponding context (e.g., “home: kitchen”) to associate with the content (e.g., Iron Chef America™). Accordingly, when the viewer is not located in the kitchen of their home, the content will not be shown on the display 402 (because the context of “home: kitchen” does not exist). The content (e.g., the Iron Chef America™) may also be added to a queue, such as a queue associated with the context (e.g., a queue of shows for watching at “home: kitchen”). When the viewer is in the kitchen of their home, the content will be shown on the display 402 as a recommendation for the viewer (because the context of “home: kitchen” will exist). As mentioned above, one of ordinary skill in the art will understand that the context may be any circumstance experienced by the viewer. Although the examples of context described herein pertain to time, weather, and location, one of ordinary skill in the art will readily understand that the features described herein are applicable to various other contexts and circumstances without deviating from the scope of the present disclosure.

As illustrated in FIG. 4D, the viewer may select one (or more) context(s) from the list of contexts 416. For example, as illustrated in FIG. 4D, the viewer may use the pointer 412 to select “Context 1.” As described above, if the context does not exist, then the content will not be displayed on the display 402 and may be added to a queue. An example of the display 402 after removal of the content (e.g., Content A 404) is illustrated in FIG. 4E. When such content (e.g., Content A 404) is removed from the display 402, an empty space 424 may remain in the display 402. In various embodiments, additional recommended content (e.g., Content E, etc. (not shown)) may subsequently be displayed in that empty space 424. One of ordinary skill in the art will understand that the examples of items shown on the display 402 are provided for illustrative purposes and are not intended to limit the scope of the present disclosure. One of ordinary skill in the art will further understand that additional, fewer, and/or alternative items may be shown on the display 402, and such items may be shown in similar or different sequences as those illustrated in FIGS. 4A-4E, without deviating from the scope of the present disclosure.

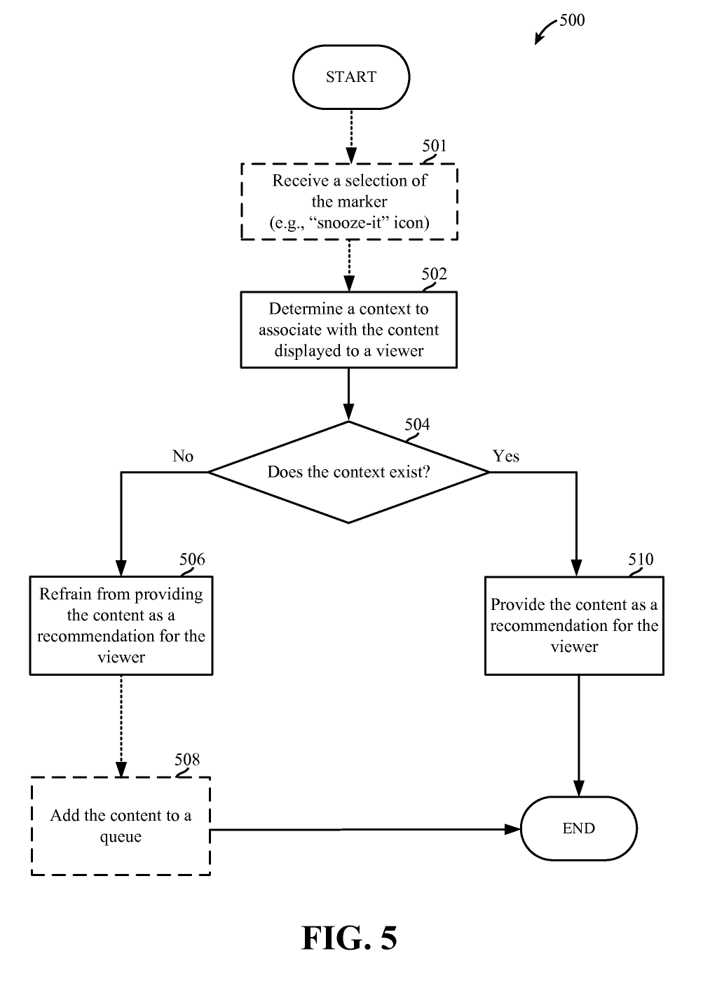

FIG. 5 is a flow diagram 500 illustrating an example of methods that may be performed according to various embodiments. The methods may be performed by various systems, devices, and/or apparatuses without deviating from the scope of the present disclosure. As a non-limiting example, the methods may be performed by one or more elements of the components 116 illustrated in FIG. 2. As described above with reference to FIGS. 3A-3C, the components 116 may be included in the mobile device 300, the entertainment system 310, and/or the computer 320. One of ordinary skill in the art will appreciate that other systems, devices, and/or apparatuses may be configured to perform the methods illustrated in FIG. 5 without deviating from the scope of the present disclosure. For the sake of illustration, the description of FIG. 5 will make reference to a “system,” although such a term shall not be construed as a limitation to the scope of the present disclosure.

At block 501, the system may receive a selection of a marker (e.g., the marker 414, which may be the “snooze-it” icon described above). For example, a viewer may select the “snooze-it” icon corresponding to a particular content displayed to the viewer. At block 502, the system may determine a context to associate with the content displayed to the viewer. For example, referring to FIG. 4D, the display 402 may show various content, such as Content A 404, Content B 406, Content C 408, and Content D 410. The system may receive a selection (e.g., a “click” using the pointer 412) of a context, such that Context 1, which is to be associated with a particular content, such as Content A. As discussed above, the context may be time-related (e.g., associating “this weekend” with the Lord of the Rings™ film series), weather-related (e.g., associating “rainy day” with the movie Sleepless in Seattle™), location-related (e.g., associating “home: kitchen” with the show Iron Chef America™), and/or any other circumstance experienced by the viewer.

At block 504, the system may determine whether the context exists. Various non-limiting examples are described above with reference to FIG. 4C. For example, the system may determine whether the current time matches the selected period of time (e.g., “this weekend”). As another example, the system may determine whether a current weather condition near the viewer matches the selected weather condition (e.g., “rainy day”). As yet another example, the system may determine whether a current location of the viewer matches the selected location (e.g., “home: kitchen”).

If the context does not exist, at block 506, the system may refrain from providing the content as a recommendation for the viewer. For example, referring to FIGS. 4D-4E, Content A 404 is removed from the display 402, thereby leaving empty space 424. In various embodiments, after the system refrains from providing the content as a recommendation for the viewer, at block 508, the system may add the content to a queue. For instance, Content A 404 may be added to a queue, such as a queue associated with movies to watch during “this weekend.” In such embodiments, the system adds the content (e.g., Content A 404) to the queue only after the system receives the selection of the marker (e.g., the “snooze-it” icon) (e.g., at block 501) and determines the context to associate with the content displayed to the viewer (e.g., at block 502). One of ordinary skill in the art will understand that the adding of the content to the queue (e.g., at block 508) is not performed repeatedly or redundantly for each instance that the same associated context does not exist.

At a later time, when the context does exist, at block 510, the system may provide the content as a recommendation for the viewer. For example, when the time-related context of “this weekend” exists, the Lord of the Rings™ film series will be provided on the display 402 as a recommendation for the viewer. As another example, when the weather-related context of “rainy day” exists, the movie Sleepless in Seattle™ will be provided on the display 402 as a recommendation for the viewer. As yet another example, when the location-related context of “home: kitchen” exists, the show Iron Chef America™ will be provided on the display 402 as a recommendation for the viewer. One of ordinary skill in the art will understand that the specific order or hierarchy of blocks in the methods described above is an illustration of embodiments. One of ordinary skill in the art further understands that the specific order or hierarchy of steps in the processes may be rearranged without deviating from the scope of the present disclosure. Further, some blocks in the methods described above may be combined and/or omitted without deviating from the scope of the present disclosure.

The disclosure provided herein discloses many structures that provide the means for performing various functions described herein. As a non-limiting example, the components 116, or any one or more subcomponents thereof, is/are structure(s) that provide(s) the means for performing various functions described herein. (As described with reference to FIGS. 3A-3C, the components 116 may be included in the mobile device 300, the entertainment system 310, and/or the computer 320.) Referring to FIG. 2, the controller 214 (e.g., a microprocessor) may provide the means for determining a context to associate with content displayed to the viewer. When the context does not exist, the controller 214 may provide the means for refraining from providing the content as a recommendation for the viewer. After refraining from providing the content as a recommendation for the viewer, the controller 214 may provide the means for adding the content to a queue. However, when the context does exist, the controller 214 may provide the means for providing the content as a recommendation for the viewer. The foregoing description is a non-limiting example of a structure (e.g., the controller 214) that may perform the means for performing the functions described herein. One of ordinary skill in the art will understand that alternative structures described herein may also perform one or more of the functions described herein. Referring to FIG. 2, the input stream processor 204 may provide the means for determining a context to associate with content displayed to the viewer. When the context does not exist, the input stream processor 204 may provide the means for refraining from providing the content as a recommendation for the viewer. After refraining from providing the content as a recommendation for the viewer, the input stream processor 204 may provide the means for adding the content to a queue. However, when the context does exist, the input stream processor 204 may provide the means for providing the content as a recommendation for the viewer. The foregoing description provides non-limiting examples of various structures (e.g., the controller 214, the input stream processor 204) that can provide the means for performing the functions described herein. The foregoing description is not intended to limit the scope of structures that can perform the functions described herein. Furthermore, such structures may also provide the means for performing additional functions.

As described above, the storage device 212 may include non-transitory computer-readable medium. The non-transitory computer-readable medium may include computer-executable instructions executable to determine a context to associate with content displayed to the viewer. The non-transitory computer-readable medium may further include computer-executable instructions executable to refrain from providing content as a recommendation for the viewer when the context does not exist. The non-transitory computer-readable medium may further include computer-executable instructions executable to add the content to a queue after refraining from providing the content as a recommendation for the viewer. The non-transitory computer-readable medium may further include computer-executable instructions executable to provide the content as a recommendation for the viewer when the context does exist. One of ordinary skill in the art will understand that such non-transitory computer-readable medium may include additional computer-executable instructions executable to perform any one or more of the other features, functions, steps, processes, and/or methods described herein without deviating from the scope of the present disclosure. One of ordinary skill in the art will further understand that such non-transitory computer-readable medium may be included in structures, components, elements, and/or circuits other than the storage device 212 without deviating from the scope of the present disclosure.

As described above, the controller 214 may include at least one processor (e.g., a microprocessor), and the storage device 212 may include memory. In various embodiments, the at least one processor and the memory may be coupled together. The at least one processor may be configured to perform various features, functions, steps, processes, and/or methods described herein. In various embodiments, the display interface 218 may provide the content to the viewer. The at least one processor may be configured to determine a context to associate with content displayed to the viewer. When the context does not exist, the at least one processor may be configured to refrain from providing the content as a recommendation for the viewer. After refraining from providing the content as a recommendation for the viewer, the at least one processor may be configured to add the content to a queue. However, when the context does exist, the at least one processor may be configured to provide the content as a recommendation for the viewer. One of ordinary skill in the art will understand that the at least one processor may be configured to perform additional and/or alternative features, functions, steps, processes, and/or methods described herein without deviating from the scope of the present disclosure. One of ordinary skill in the art will further understand that the at least one processor may be included in structures, components, elements, and/or circuits other than the storage device 212 without deviating from the scope of the present disclosure.

As will be appreciated by one skilled in the art, aspects of the present principles can be embodied as a system, method or computer readable medium. Accordingly, aspects of the present principles can take the form of an entirely hardware embodiment, an entirely software embodiment (including firmware, resident software, micro-code, and so forth), or an embodiment combining software and hardware aspects that can all generally be referred to herein as a “circuit,” “module”, or “system.” Furthermore, aspects of the present principles can take the form of a computer readable storage medium. Any combination of one or more computer readable storage medium(s) may be utilized.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

It will be appreciated by those skilled in the art that the block diagrams presented herein represent conceptual views of illustrative system components and/or circuitry embodying the principles of the present disclosure. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown.

The features described herein and illustrated in the accompanying drawings may be shown using various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

The foregoing description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method for recommending content to a viewer, the method comprising:
determining a condition to associate with the content;
refraining from providing the content as a recommendation for the viewer when the condition does not exist; and
providing the content as a recommendation for the viewer when the condition exists, wherein the recommendation is a queue associated with the condition for the content.

2. The method of claim 1, further comprising:
adding the content to the queue after refraining from providing the content as a recommendation for the viewer.

3. (canceled)

4. The method of claim 1, wherein the condition is included in a list of conditions displayed to the viewer.

5. The method of claim 1, wherein:
the condition comprises a period of time selected by the viewer; and
the condition exists when a current time is during the selected period of time.

6. The method of claim 1, wherein:
the condition comprises a weather condition selected by the viewer; and
the condition exists when a current weather condition near the viewer matches the selected weather condition.

7. The method of claim 1, wherein:
the condition comprises a location selected by the viewer; and
the condition exists when a current location of the viewer matches the selected location.

8. An apparatus for recommending content to a viewer, the apparatus comprising:
a memory; and
at least one processor coupled to the memory and configured to:
determine a condition to associate with content;
refrain from providing the content as a recommendation for the viewer when the condition does not exist; and
provide the content as a recommendation for the viewer when the condition exists, wherein the recommendation is a queue associated with the condition for the content.

9. The apparatus of claim 8, wherein the at least one processor is further configured to:
add the content to the queue after refraining from providing the content as a recommendation for the viewer.

10. (canceled)

11. The apparatus of claim 8, wherein the condition is included in a list of conditions displayed to the viewer.

12. The apparatus of claim 8, wherein:
the condition comprises a period of time selected by the viewer; and
the condition exists when a current time is during the selected period of time.

13. The apparatus of claim 8, wherein:
the condition comprises a weather condition selected by the viewer; and
the condition exists when a current weather condition near the viewer matches the selected weather condition.

14. The apparatus of claim 8, wherein:
the condition comprises a location selected by the viewer; and
the condition exists when a current location of the viewer matches the selected location.

15. A non-transitory computer-readable medium comprising computer-executable instructions executable by a processor to:
determine a condition to associate with content;
refrain from providing the content as s recommendation for the viewer when the condition does not exist; and
provide the content as a recommendation for the viewer when the condition exists, wherein the recommendation is a queue associated with the condition for the content.

16. The non-transitory computer-readable medium of claim 15, wherein the non-transitory computer-readable medium further comprises computer-executable instructions executable to:
add the content to the queue after refraining from providing the content as a recommendation for the viewer.

17. (canceled)

18. The non-transitory computer-readable medium of claim 15, wherein the condition is included in a list of contexts conditions displayed to the viewer.

19. The non-transitory computer-readable medium of claim 15, wherein:
the condition comprises a period of time selected by the viewer; and
the condition exists when a current time is during the selected period of time.

20. The non-transitory computer-readable medium of claim 15, wherein:
the condition comprises a weather condition selected by the viewer; and
the condition exits when a current weather condition near the viewer matches the selected weather condition.

21. The non-transitory computer-readable medium of claim 15, wherein:
the condition comprises a location selected by the viewer; and
the condition exists when a current location of the viewer matches the selected location.

22. An apparatus for recommending content to a viewer, the apparatus comprising:
means for determining a condition to associate with content;
means for refraining from providing the content as a recommendation for the viewer when the condition does not exist; and
means for providing the content as a recommendation for the viewer when the condition exists, wherein the recommendation is a queue associated with the condition for the content.

23. The apparatus of claim 22, further comprising:
means for adding the content to the queue after refraining from providing the content as a recommendation for the viewer.

24. (canceled)

25. The apparatus of claim 22, wherein the condition is included in a list of conditions displayed to the viewer.

26. The apparatus of claim 22, wherein:
the condition comprises a period of time selected by the viewer; and
the condition exists when a current time is during the selected period of time.

27. The apparatus of claim 22, wherein:
the condition comprises a weather condition selected by the viewer; and
the condition exists when a current weather condition near the viewer matches the selected weather condition.

28. The apparatus of claim 22, wherein:
the condition comprises a location selected by the viewer; and
the condition exists when a current location of the viewer matches the selected location.
